(19) United States
(12) Patent Application Publication
(10) Pub. No.: US 2006/0078779 A1
(43) Pub. Date: Apr. 13, 2006

(54) Draining device for use with fuel cell system

(75) Inventors: Chen-Yu Yu, Taoyuan Hsien (TW); Hsi-An Liu, Taoyuan Hsien (TW); Sheng-Yan Hu, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/145,741

(22) Filed: Jun. 6, 2005

(30) Foreign Application Priority Data
Oct. 13, 2004 (TW) 093131053

(51) Int. Cl. H01M 8/04

(52) U.S. Cl. 429/34; 429/26

(57) ABSTRACT

A draining device for use with a fuel cell system includes a recovery tank, a water-absorbing article and a blower. The fuel cell system performs an electrochemical reaction to produce water and heat. The recovery tank is in communication with the fuel cell system and includes a plurality of openings and a receptacle for accommodating the water. The water-absorbing article is disposed within the receptacle of the recovery tank for absorbing and dispersing the water. The blower is in communication with the recovery tank for introducing ambient air into the recovery tank. The water is vaporized into steam by the heat produced from the electrochemical reaction of the fuel cell system. The ambient air introduced by the blower forces the steam to discharge to the surroundings via the openings of the recovery tank.

### FIELD OF THE INVENTION

The present invention relates to a draining device, and more particularly to a draining device for use with a fuel cell system.

### BACKGROUND OF THE INVENTION

Fuel cells are well known and are commonly used to produce electrical energy by means of electrochemical reactions. Comparing to the conventional power generation apparatus, fuel cells have advantages of less pollutant, lower noise generated, increased energy density and higher energy conversion efficiency. Fuel cells can be used in portable electronic products, home-use or plant-use power generation systems, transportation, military equipment, the space industry, large-size power generation systems, etc.

According to the electrolytes used, fuel cells are typically classified into several types, e.g. an alkaline fuel cell (AFC), a phosphoric acid fuel cell (PAFC), a molten carbonate fuel cell (MCFC), a solid oxide fuel cell (SOFC) and a proton exchange membrane (PEMFC). Depending on types of the fuel cells, the operation principles are somewhat different. For example, in the case of a direct methanol fuel cell (DMFC) which has the same structure as the PEMFC but uses liquid methanol instead of hydrogen as a fuel source, methanol is supplied to the anode, an oxidation reaction occurs in the presence of a catalyst, and protons, electrons and carbon dioxide are generated. The protons reach the cathode through the proton exchange membrane. Meanwhile, in the cathode, oxygen molecules take electrons from the anode and are reduced to oxygen ions by reduction. The oxygen ions react with hydrogen ions from the anode and thus produce water.

As know, an individual fuel cell unit supplies limited voltage (approximately 0.4 V). For a purpose of offering a sufficient operating voltage to an electronic product, a plurality of fuel cell units should be connected in series so as to form a fuel cell assembly. Depending on the arrangement of the fuel cell units, the fuel cell assemblies can be divided into two types, i.e. a stacked fell cell assembly and a planar fell cell assembly.

Referring to FIG. 1, an exploded view of a conventional stacked fell cell assembly is illustrated. The stacked fell cell assembly 10 comprises at least two membrane-electrolyte assemblies (MEAs) 11, a bipolar plate 12 located between two adjacent MEAs 11 and two electrode plates 13 and 14 at opposite ends of the cell assembly. Each MEA 11 includes an anode 111, a proton exchange membrane 112 and a cathode 113. The bipolar plate 12 comprises a plurality of channels 121 for flowing fuels and oxygen molecules therethrough. However, since the stacked fell cell assembly 10 requires a large amount of cell units to be assembled in a stacked form, the thickness and the weight thereof are considerably high. Therefore, the usage of such stacked fell cell assembly is restricted in some situations.

Referring to FIG. 2, a planar fuel cell assembly 20 comprises a metal frame 21, a plurality of membrane-electrolyte assemblies (MEAs) 22 and two electrode plates 23 and 24 at opposite ends of the cell assembly. Likewise, each MEA 22 includes an anode, a proton exchange membrane and a cathode (not shown), and is embedded in the corresponding openings 211 of the frame 21. Furthermore, two current collectors 212 are disposed at one side of the frame 21 as the current output terminals of the planar fuel cell assembly 20. Each of the electrode plates 23 and 24 comprises channels 231 for flowing fuels and oxygen molecules therethrough. Since such planar fuel cell assembly 20 is advantageous of being easily assembled and having less weight, thickness and volume, it is widely used in portable electronic products.

As previously described, fluid fuel and oxygen should be continuously offered in order to carry out the oxidation-reduction reaction and generate electricity. As known, since water produced from the oxidation-reduction reaction is usually discharged to the surroundings, several problems may occur. For example, the produced water may contaminate the surroundings of the fuel cell system. In addition, if the produced water is not properly removed, the electric safety problem will be happened.

In views of the above-described disadvantages resulted from the prior art, the applicant keeps on carving unflaggingly to develop a draining device for use with a fuel cell system according to the present invention through wholehearted experience and research.

### SUMMARY OF THE INVENTION

The present invention provides a draining device for use with a fuel cell system so as to direct the produced water of the fuel cell system to the surroundings, thereby overcoming the problems associated with the environmental contamination and electric safety.

In accordance with a first aspect of the present invention, there is provided a draining device for use with a fuel cell system. The fuel cell system performs an electrochemical reaction to produce water and heat. The draining device comprises a recovery tank, a water-absorbing article and a blower. The recovery tank is in communication with the fuel cell system and comprises a plurality of openings and a receptacle for accommodating the water. The water-absorbing article is disposed within the receptacle of the recovery tank for absorbing and dispersing the water. The blower is in communication with the recovery tank for introducing ambient air into the recovery tank. The water is vaporized into steam by the heat produced from the electrochemical reaction of the fuel cell system. The ambient air introduced by the blower forces the steam to discharge to the surroundings via the openings of the recovery tank.

In an embodiment, the openings are arranged on a side of the recovery tank.

Preferably, the water-absorbing article is selected from a group consisting of cotton cloth, a paper and a fiber.

In an embodiment, the fuel cell system comprises a fuel cell assembly for performing the electrochemical reaction to produce the water and the heat.

In accordance with a second aspect of the present invention, there is provided a fuel cell system. The fuel cell system comprises a fuel cell assembly and a draining device. The fuel cell assembly performs an electrochemical reaction to produce water and heat. The draining device is used for discharging the water, and comprises a recovery tank a recovery tank and a blower. The recovery tank is in communication with the fuel cell assembly and comprises a plurality of openings and a receptacle for accommodating the water. The water-absorbing article is disposed within the receptacle of the recovery tank for absorbing and dispersing the water. The blower is in communication with the recovery tank for introducing ambient air into the recovery tank. The water is vaporized into steam by the heat produced from the electrochemical reaction of the fuel cell system, and the ambient air introduced by the blower forces the steam to discharge to the surroundings via the openings of the recovery tank.

In an embodiment, the fuel cell system further comprises a heat sink coupled to the fuel cell assembly for dissipating the heat from the fuel cell assembly and vaporizing the water into steam by the heat.

In an embodiment, the heat sink further comprises a water inlet, a water-collecting space and at least one aperture. Via the water inlet, water is introduced into the heat sink. The water-collecting space contains the water such that a portion of water is vaporized into steam in said water-collecting space. Via the aperture, the steam is discharged.

In an embodiment, the heat sink further comprises a plurality of water-leaking holes and a plurality of fins. The water-leaking holes are arranged under the water-collecting space for penetrating the water having not been vaporized therethrough. The fins are used for enhancing area of heat dissipation and allowing the water having not been vaporized to flow along the surfaces thereof and drop down to the recovery tank.

In accordance with a third aspect of the present invention, there is provided a fuel cell system. The fuel cell system comprises a fuel cell assembly, a heat sink and a draining device. The fuel cell assembly performs an electrochemical reaction to produce water and heat. The heat sink is coupled to the fuel cell assembly for dissipating the heat from the fuel cell assembly and vaporizing the water into steam by the heat. The draining device is used for discharging the water, and comprises a recovery tank a recovery tank and a blower. The recovery tank is in communication with the fuel cell assembly and comprises a plurality of openings and a receptacle for accommodating the water, the water-absorbing article is disposed within the receptacle of the recovery tank for absorbing and dispersing the water, and the blower is in communication with the recovery tank for introducing ambient air into the recovery tank. The water is vaporized into steam by the heat produced from the electrochemical reaction of the fuel cell system, and the ambient air introduced by the blower forces the steam to discharge to the surroundings via the openings of the recovery tank.

Preferably, the steam is discharged to the surroundings or recycled to a cathode side of the fuel cell assembly.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view of a stacked fell cell assembly according to prior art;

FIG. 2 is a schematic exploded view of a planar fell cell assembly according to prior art;

FIG. 3(a) is a schematic perspective view illustrating a fuel cell system according to a preferred embodiment of the present invention;

FIG. 3(b) is a schematic perspective view illustrating the draining device for use with the fuel cell system of FIG. 3(a);

FIG. 3(c) is a schematic perspective view illustrating the fuel cell system of FIG. 3(a) in combination with the draining device of FIG. 3(b);

FIGS. 4(a), 4(b) and 4(c) are schematic views illustrating a heat sink for use with the fuel cell system according to a second preferred embodiment of the present invention;

FIG. 4(d) is a schematic view illustrating another heat sink;

FIG. 5(a) is a schematic exploded view illustrating the fuel cell system according to the second preferred embodiment of the present invention; and

FIG. 5(b) is a schematic assembled view illustrating the fuel cell system of FIG. 5(a).

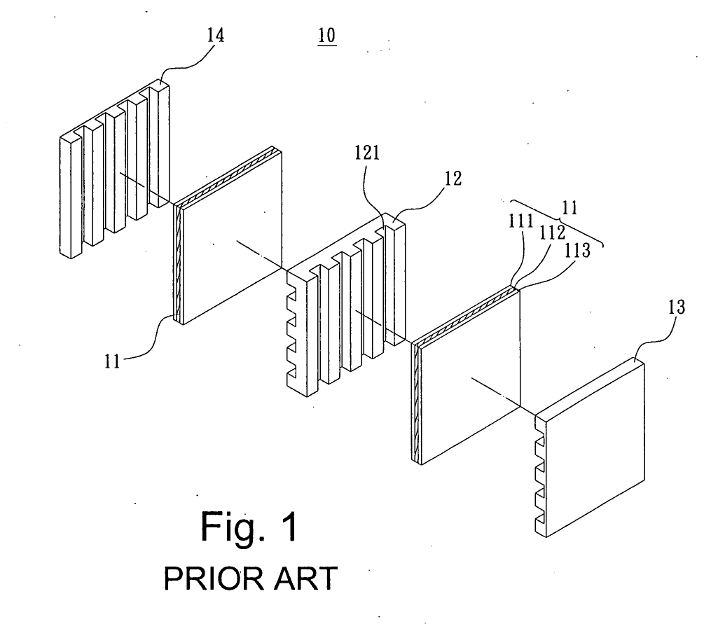

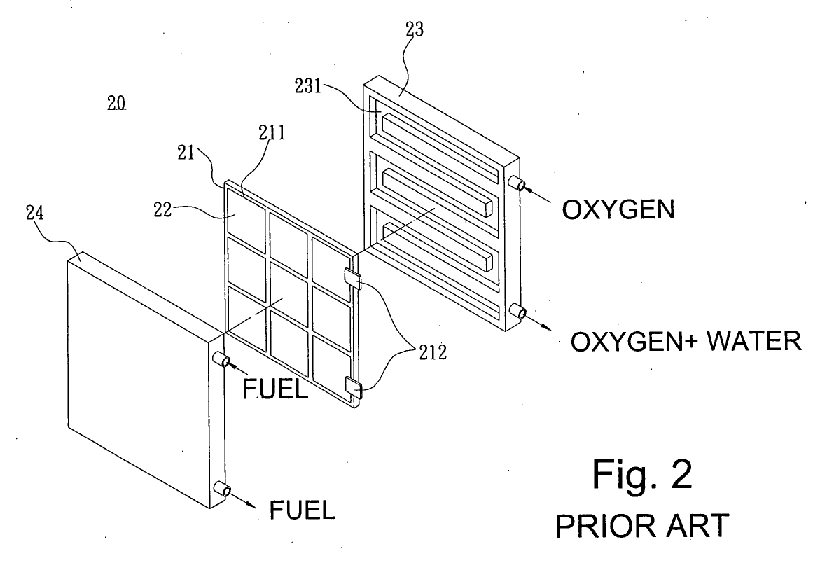

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

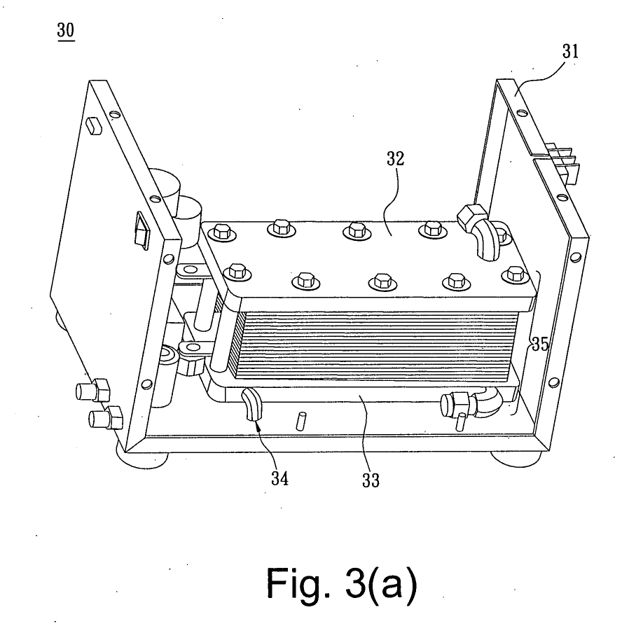

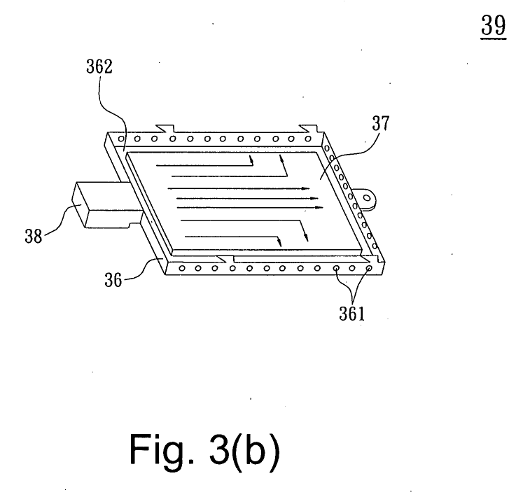

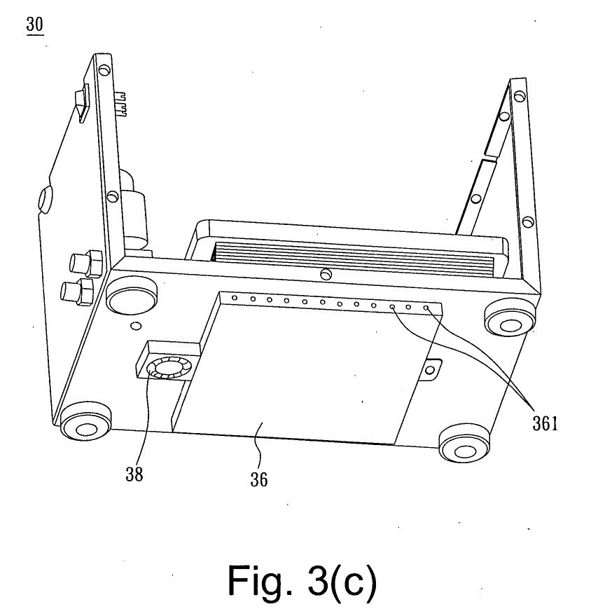

Referring to FIG. 3(a), a fuel cell system according to a preferred embodiment of the present invention is illustrated. The fuel cell system 30 is a stacked-type fuel cell system, and comprises a housing 31, a draining pipe 34 and a fuel cell assembly 35 including an upper electrode plate 32 and a lower electrode plate 33. In an embodiment, the lower electrode plate 33 of the fuel cell assembly 35 is in close contact with the housing 31. Alternatively, the lower electrode plate 33 is distant from the housing 31 by a gap. A fluid fuel and oxygen gas are introduced into the fuel cell assembly 35 and an oxidation-reduction reaction is carried out in the fuel cell assembly 35 to produce electricity, water and heat. Via the draining pipe 34, the produced water will be discharged to a recovery tank 36 as shown in FIG. 3(b).

Referring to FIG. 3(b), a draining device for use with the fuel cell system of FIG. 3(a) is illustrated. The draining device comprises the recovery tank 36, a water-absorbing article 37 and a blower 38. As shown in FIG. 3(c), the recovery tank 36 is disposed under the fuel cell assembly 35 for accommodating the water produced from the fuel cell assembly 35 via the draining pipe 34. The recovery tank 36 comprises a plurality of openings 361 at a side thereof and a receptacle 362 facing to the fuel cell assembly 35. The recovery tank 36 is fixed on the bottom of the fuel cell system 30 by fastening, screwing or gliding means according to the manufacturer's design. The recovery tank 36 is preferably in a rectangular shape.

The water-absorbing article 37 is disposed within the receptacle 362 of the recovery tank 36 and capable of absorbing the water droplets falling from the draining pipe 34 and dispersing the absorbed water molecules by a capillary action. Examples of the water-absorbing article 37 include but are not limited to a cotton cloth, a paper, a fiber or other material having desired pores.

The blower 38 is arranged on a side of the recovery tank 36 and in communication with the recovery tank 36. During operation of the blower 38, the ambient air is introduced into the recovery tank 36. Since the temperature of the recovery tank 36 will be increased due to the heat generated from the oxidation-reduction reaction of the fuel cell assembly 35, the saturated vapor pressure of air will be increased and thus the moisture content of air is increased. In this circumstance, the water contained in the water-absorbing article 37 will be vaporized into steam. Afterwards, the ambient air introduced by the blower 38 will force the steam to discharge to the surroundings via the openings 361 at one side of the recovery tank 36.

Since the water collected in the recovery tank 36 is vaporized into steam by the heat generated from the oxidation-reduction reaction of the fuel cell assembly 35 and the steam is discharged to the surroundings by the ambient air introduced from the blower 38, the problems associated with environmental contamination and electric safety will be overcome.

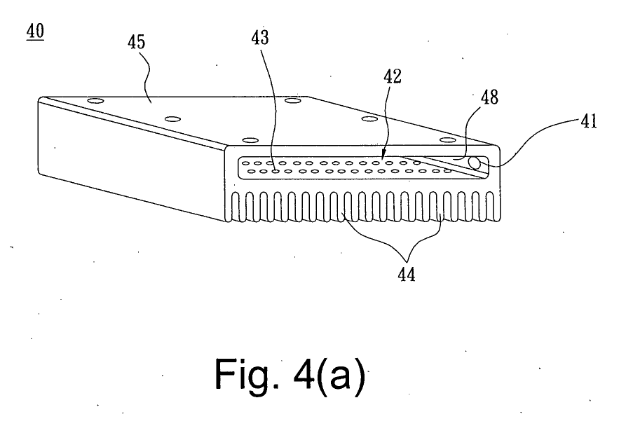

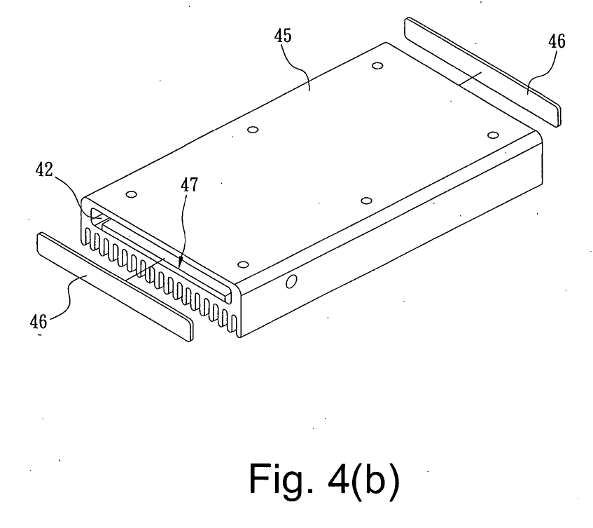

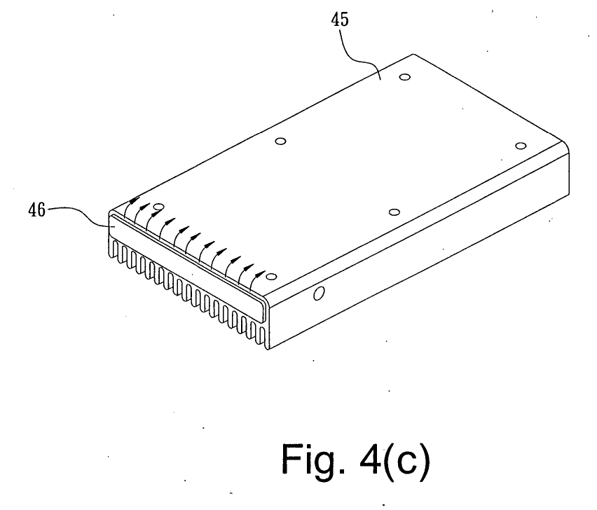

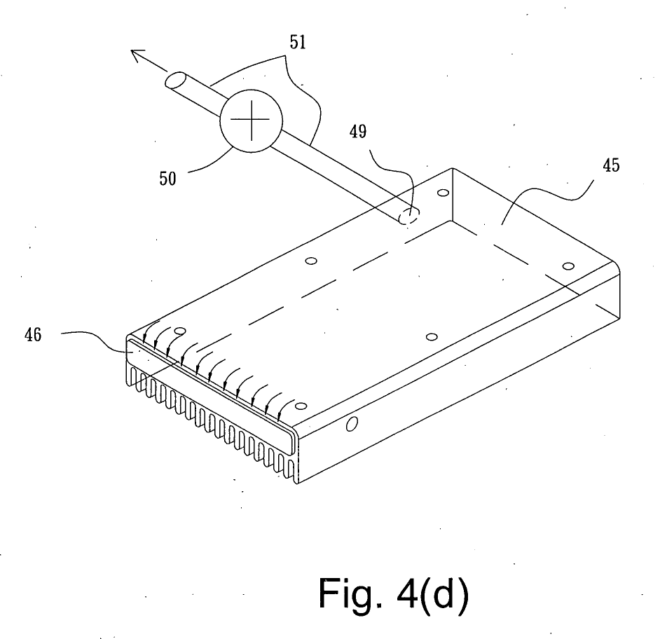

A further embodiment of a fuel cell system is illustrated in FIGS. 4(a) and 4(b). In this embodiment, the fuel cell assembly and the draining device included therein are similar to those shown in FIG. 3, and are not to be redundantly described herein. In this embodiment, a heat sink 40 is further arranged between the fuel cell assembly 35 and the draining device so as to increase the area and speed for heat dissipation. The heat sink 40 shown in FIGS. 4(a) and 4(b) comprises a water inlet 41, font-end and rear-end apertures 42, a plurality of water-leaking holes 43, a plurality of fins 44, a heat sink main body 45, two covering plates 46 and a water-collecting space 48. The font-end and rear-end apertures 42 can be covered by the covering plates 46, respectively. The water-leaking holes 43 are disposed under the water-collecting space 48.

The water inlet 41 is in communication with the draining pipe 34 of the fuel cell system 30 as shown in FIG. 3 for receiving the water produced from the fuel cell assembly 35. Since the temperature of the heat sink 40 will be increased due to the heat generated from the oxidation-reduction reaction of the fuel cell assembly 35, the saturated vapor pressure of air in the water-collecting space 48 will be increased. In this circumstance, a portion of the water flowing through the water-collecting space 48 will be vaporized into steam. As shown in FIG. 4(b), a water-absorbing article 47 is arranged above the water-leaking holes 43 for absorbing the water droplets falling from the draining pipe 34 and dispersing the absorbed water molecules by a capillary action. The vaporized steam will be discharged to surroundings through the chinks between the font-end and rear-end apertures 42 and the corresponding covering plates 46.

Furthermore, in views of environmental protection, the steam generated in the water-collecting space 48 can be recycled for use. As shown in FIG. 4(d), a steam outlet 49 is disposed on a side of the heat sink main body 45. The steam outlet 49 is in communication with an air-extracting motor 50 via a conduit pipe 51. The other end of the air-extracting motor 50 is coupled to the cathode side (not shown) of the fuel cell assembly 35. By means of the air-extracting motor 50, the steam generated in the water-collecting space 48 will be pumped out to the cathode side of the fuel cell assembly 35 so as to wet the electrode in the cathode side. During the steam is pumped out to the cathode side of the fuel cell assembly 35, the ambient air will be also introduced into the water-collecting space 48 through the chinks between the font-end and rear-end apertures 42 and the corresponding covering plates 46.

Please refer to FIG. 4(a) again. The water having not been vaporized will penetrate through the water-leaking holes 43 of the heat sink 40, flow along the surfaces of the fins 44 and drop down to the recovery tank 36. By the way, a portion of water flowing along the surfaces of the fins 44 may be vaporized into steam.

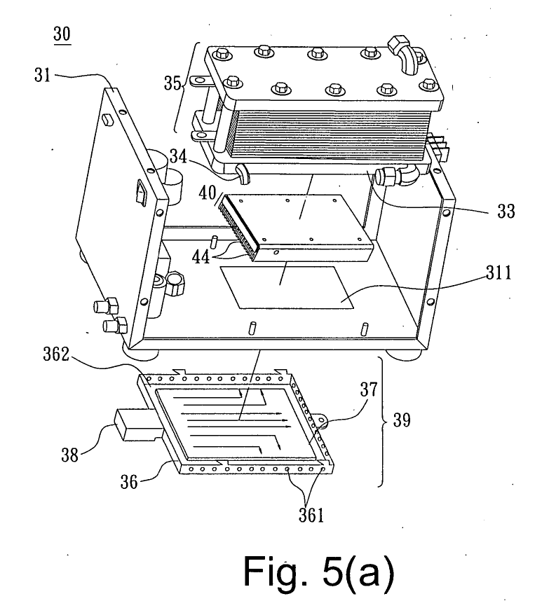

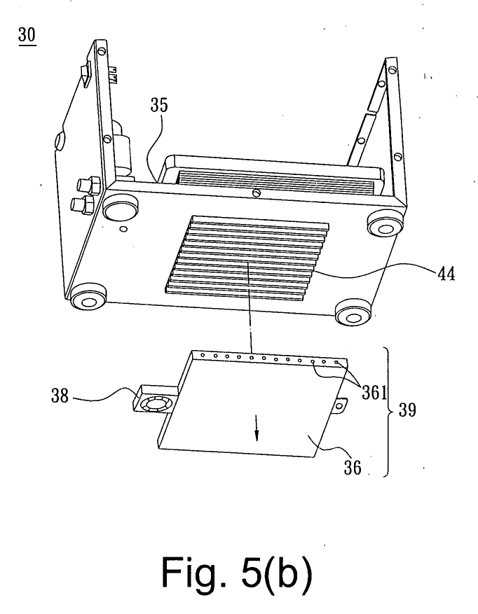

Referring to FIG. 5(a), a schematic exploded view of a fuel cell system according to a second preferred embodiment of the present invention is illustrated. In this embodiment, the housing 31, the draining pipe 34, the fuel cell assembly 35 and the draining device 39 included therein are similar to those shown in FIG. 3, and are not to be redundantly described herein. In addition, the fuel cell system 30 further comprises the heat sink 40. This heat sink 40 is disposed between the fuel cell assembly 35 and the draining device 39 and in close contact with the lower electrode plate 33 of the fuel cell assembly 35. By means of the heat sink 40, a portion of the water produced from the oxidation-reduction reaction in the fuel cell assembly 35 will be vaporized into steam due to the generated heat. As shown in FIG. 5(b), after the tip portions of the fins 44 penetrate through a hollow region 311 in the bottom surface of the housing 31, the draining device 39 will be secured onto the bottom of housing 31 so as to assemble the fuel cell system of this embodiment. Likewise, the water having not been vaporized will flow along the surfaces of the fins 44 and drop down to the recovery tank 36. In addition, the water contained in the water-absorbing article 37 will be vaporized into steam due to the heat generated from the oxidation-reduction reaction in the fuel cell assembly 35. Afterwards, the ambient air introduced by the blower 38 will force the steam to discharge to the surroundings via the openings 361 at one side of the recovery tank 36.

From the above description, the draining device of the present invention is capable of rapidly absorbing and dispersing the water droplets by using the water-absorbing article, and thus the area and the speed for vaporizing the water into steam are enhanced. In addition, since the temperature of the recovery tank will be increased due to the heat generated from the oxidation-reduction reaction of the fuel cell assembly, the saturated vapor pressure of air will be increased and thus the moisture content of air is increased. In this circumstance, the water contained in the water-absorbing article 37 will be vaporized into steam. Afterwards, the ambient air introduced by the blower will force the steam to discharge to the surroundings via the openings at one side of the recovery tank. Moreover, the problems associated with the environmental contamination and electric safety will be overcome because the produced water is vaporized into steam.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A draining device for use with a fuel cell system, said fuel cell system performing an electrochemical reaction to produce water and heat, said draining device comprising:
a recovery tank in communication with said fuel cell system and comprising a plurality of openings and a receptacle for accommodating said water;
a water-absorbing article disposed within said receptacle of said recovery tank for absorbing and dispersing said water; and
a blower in communication with said recovery tank for introducing ambient air into said recovery tank,
wherein said water is vaporized into steam by the heat produced from said electrochemical reaction of said fuel cell system, and said ambient air introduced by said blower forces said steam to discharge to the surroundings via said openings of said recovery tank.

2. The draining device according to claim 1 wherein said openings are arranged on a side of said recovery tank.

3. The draining device according to claim 1 wherein said water-absorbing article is selected from a group consisting of cotton cloth, a paper and a fiber.

4. The draining device according to claim 1 wherein said fuel cell system comprises a fuel cell assembly for performing said electrochemical reaction to produce said water and said heat.

5. A fuel cell system comprising:
a fuel cell assembly for performing an electrochemical reaction to produce water and heat; and
a draining device for discharging said water, and comprising a recovery tank, a water-absorbing article and a blower, wherein said recovery tank is in communication with said fuel cell assembly and comprises a plurality of openings and a receptacle for accommodating said water, said water-absorbing article is disposed within said receptacle of said recovery tank for absorbing and dispersing said water, and said blower is in communication with said recovery tank for introducing ambient air into said recovery tank,
wherein said water is vaporized into steam by the heat produced from said electrochemical reaction of said fuel cell system, and said ambient air introduced by said blower forces said steam to discharge to the surroundings via said openings of said recovery tank.

6. The fuel cell system according to claim 5 further comprising a heat sink coupled to said fuel cell assembly for dissipating said heat from said fuel cell assembly and vaporizing said water into steam by said heat.

7. The fuel cell system according to claim 6 wherein said heat sink further comprises:
a water inlet for introducing said water into said heat sink therevia;
a water-collecting space containing said water such that a portion of water is vaporized into steam in said water-collecting space; and
at least one aperture for discharging said steam therevia.

8. The fuel cell system according to claim 7 wherein said heat sink further comprises:
a plurality of water-leaking holes arranged under said water-collecting space for penetrating the water having not been vaporized therethrough; and
a plurality of fins for enhancing area of heat dissipation and allowing the water having not been vaporized to flow along the surfaces thereof and drop down to said recovery tank.

9. The fuel cell system according to claim 5 wherein said water-absorbing article is selected from a group consisting of cotton cloth, a paper and a fiber.

10. The fuel cell system according to claim 5 wherein said openings are arranged on a side of said recovery tank.

11. A fuel cell system comprising:
a fuel cell assembly for performing an electrochemical reaction to produce water and heat;
a heat sink coupled to said fuel cell assembly for dissipating said heat from said fuel cell assembly and vaporizing said water into steam by said heat; and
a draining device for discharging said water, and comprising a recovery tank, a water-absorbing article and a blower, wherein said recovery tank is in communication with said fuel cell assembly and comprises a plurality of openings and a receptacle for accommodating said water, said water-absorbing article is disposed within said receptacle of said recovery tank for absorbing and dispersing said water, and said blower is in communication with said recovery tank for introducing ambient air into said recovery tank,
wherein said water is vaporized into steam by the heat produced from said electrochemical reaction of said fuel cell system, and said ambient air introduced by said blower forces said steam to discharge to the surroundings via said openings of said recovery tank.

12. The fuel cell system according to claim 11 wherein said steam is discharged to the surroundings or recycled to a cathode side of said fuel cell assembly.

13. The fuel cell system according to claim 11 wherein said heat sink further comprises:
a water inlet for introducing said water into said heat sink therevia;
a water-collecting space containing said water such that a portion of water is vaporized into steam in said water-collecting space; and
at least one aperture for discharging said steam therevia.

14. The fuel cell system according to claim 13 wherein said heat sink further comprises:
a plurality of water-leaking holes arranged under said water-collecting space for penetrating the water having not been vaporized therethrough; and
a plurality of fins for enhancing area of heat dissipation and allowing the water having not been vaporized to flow along the surfaces thereof and drop down to said recovery tank.

15. The fuel cell system according to claim 11 wherein said water-absorbing article is selected from a group consisting of cotton cloth, a paper and a fiber.

16. The fuel cell system according to claim 11 wherein said openings are arranged on a side of said recovery tank.
